(19) United States
(12) Patent Application Publication
(10) Pub. No.: US 2013/0002452 A1
(43) Pub. Date: Jan. 3, 2013

(54) Light-weight, portable, and wireless navigator for determining when a user who is visually-impaired and/or poorly-oriented can safely cross a street, with or without a traffic light, and know his/her exact location at any given time, and given correct and detailed guidance for translocation

(76) Inventor: David Lauren, Forest Hills, NY (US)

(21) Appl. No.: 13/135,372

(22) Filed: Jul. 1, 2011

(51) Int. Cl. G08G 1/09

(52) U.S. Cl. 340/944

(57) ABSTRACT

A light-weight, portable, and wireless navigator for determining when a user who is visually-impaired and/or poorly-oriented can safely cross a street, with or without a traffic light, and know his/her exact location at any given time, and given correct and detailed guidance for translocation. The navigator includes a first microcomputer, a transmitter, a receiver, a second microcomputer, and an alerting device. The first microcomputer is disposed at the traffic light and determines light status of the traffic light. The transmitter is operatively connected to the first microcomputer, and generates a signal indicative of the light status of the traffic light. The receiver is hand-held/portable disposed with the user, and wirelessly receives the signal generated by the transmitter. The second microcomputer is hand-held/portable disposed with the user, is operatively connected to the receiver, and in response to the signal received by the receiver, causes the alerting device to indicate to the user the light status of the traffic light, the identification of the street, and the exact location of the user on that street so as to allow the user to identify the street and safely cross the street.

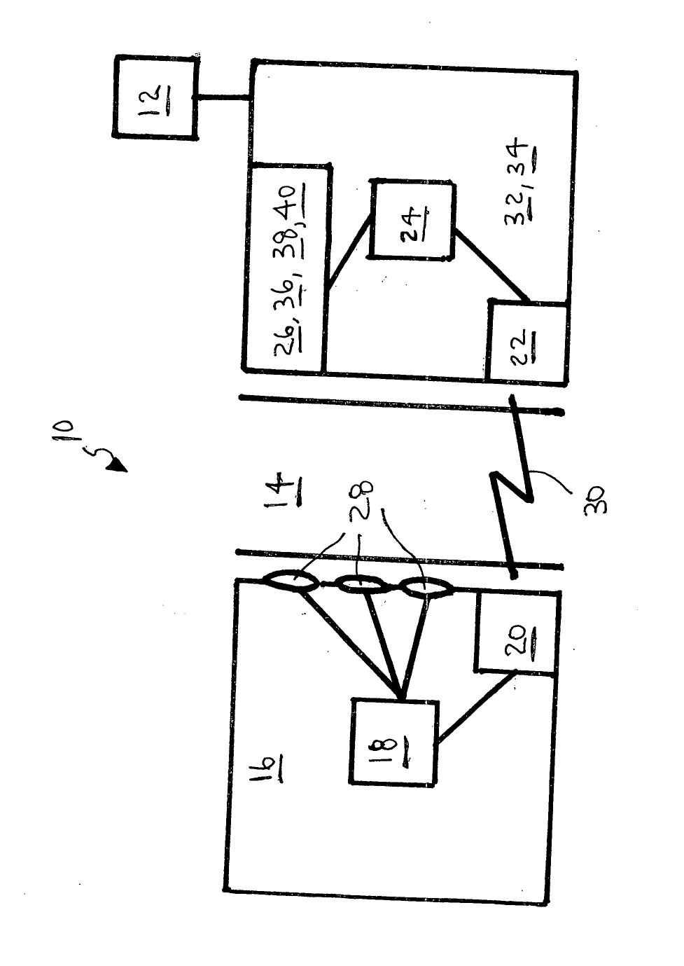

### 1. BACKGROUND OF THE INVENTION

A. Field of the Invention

The embodiments of the present invention relate to a navigator, and more particularly, the embodiments of the present invention relate to a light-weight, portable, and wireless navigator for determining when a user who is visually-impaired and/or poorly-oriented can safely cross a street, with or without a traffic light, and know his/her exact location at any given time, and given correct and detailed guidance for translocation.

B. Description of the Prior Art

Numerous innovations for navigators have been provided in the prior art, which will be described below in chronological order to show advancement in the art, and which are incorporated herein by reference thereto. Even though these innovations may be suitable for the specific individual purposes to which they address, nevertheless, they differ from the embodiments of the present invention in that they do not teach a light-weight, portable, and wireless navigator for determining when a user who is visually-impaired and/or poorly-oriented can safely cross a street, with or without a traffic light, and know his/her exact location at any given time, and given correct and detailed guidance for translocation.

(1) U.S. Pat. No. 5,687,136 to Borenstein.

U.S. Pat. No. 5,687,136 issued to Borenstein on Nov. 11, 1997 in U.S. class 367 and subclass 116 teaches a user-driven and active guidance system for guiding visually impaired users through obstacle-filled routes of travel. The system includes an obstacle detection system having an array of ultrasonic sensors detecting the distance to and location of obstacles, and a controller for receiving obstacle data and determining an optimal path around the obstacle so as to return the user back to the original path of travel without losing orientation or direction. The system provides active guidance by exerting physical force upon the user to intuitively direct the user around the obstacle. The system is driven by the user's motion, and includes a cane, as well as ultrasonic sensors and a controller supported on a pair of guide wheels.

(2) U.S. Pat. No. 6,502,032 B1 to Newman.

U.S. Pat. No. 6,502,032 B1 issued to Newman on Dec. 31, 2002 in U.S. class 701 and subclass 213 teaches a global positioning system that actively guides blind pedestrians and military/police forces. This system uses a DOD Global Positioning System (GPS) to provide user position and navigation to centimeter accuracy. Present position and navigation requests are digitally cellular telephoned to a central “base station” where data is correlated with a computerized map database that holds names and coordinates of specific locations, such as streets, intersections, traffic lights, hospitals, bathrooms, public telephones, and internal layouts of major buildings and facilities in selected regions, cities, and neighborhoods. The system operates by a user entering a desired destination into a hand-held unit via voice recognition software or using a Braille keyboard. The hand-held unit then transmits the present position (PP), via GPS satellite signals and desired destination, to a base station that contains a map database and a surveyor quality GPS computer system.

(3) U.S. Pat. No. 6,581,000 B2 to Hills et al.

U.S. Pat. No. 6,581,000 B2 issued to Hills et al. on Jun. 17, 2003 in U.S. class 701 and subclass 207 teaches a system for determining a position of a user. The system includes a distance sensor in communication with a position tracking device. The distance sensor is for detecting movement by the user, and the position tracking device is for determining the position of the user based on detection of movement by the user and a relative change in direction input from the user.

### (4) United States Patent Application Publication Number US 2003/0161508 A1 to Lindahl et al.

United States Patent Application Publication Number US 2003/0161508 A1 published to Lindahl et al. on Aug. 28, 2003 in U.S. class 382 and subclass 123 teaches a system and a method for interpreting visual information and transmitting it to a human being through tactile influence of sensorial organs in its body. The system has a sensor module capturing visual information, and a control module interpreting the captured information and controlling a tactile actuator module in accordance with the interpreted information. An actuator module transmits the interpreted information to a human being by electro-mechanically influencing sensorial organs in the skin of the human being, thereby creating an image in its brain. An image corresponding to the visual information is transmitted through the electro-mechanical actuator module.

(5) U.S. Pat. No. 6,774,788 B1 to Balfe.

U.S. Pat. No. 6,774,788 B1 issued to Balfe on Aug. 10, 2004 in U.S. class 340 and subclass 539.13 teaches a handheld navigation device for use by the visually impaired, which has a camera electrically connected to a microprocessor. The microprocessor is capable of object and character recognition and translation into Braille. A Braille display is electrically connected to the microprocessor. A speaker is electrically connected to the microprocessor for audibly communicating common objects and distances and character recognition translations to the user.

### (6) United States Patent Application Publication Number US 2006/0293839 A1 to Stankieiwcz et al.

United States Patent Application Publication Number US 2006/0293839 A1 published to Stankieiwcz et al. on Dec. 28, 2006 in U.S. class 701 and subclass 200 teaches a system, method, and apparatus to assist a user navigate from a current location to a second location within an environment by determining a distance traveled by the user or from the user to one or more objects. The current location is then identified using the distance and environment data. Thereafter, a route to the second location is determined based on the current location and the environment data. A directional cue is provided to the user based on the route. The system, method, and apparatus can be implemented as a computer program embodied on a computer readable medium, wherein the steps are performed by one or more code segments.

(7) U.S. Pat. No. 7,366,499 B1 to Michaelis.

U.S. Pat. No. 7,366,499 B1 issued to Michaelis on Apr. 29, 2008 in U.S. class 455 and subclass 413 teaches a visually-impaired person possessing a GPS-equipped cellular phone, or other mobile communications device, who wants to know their location, uses the cellular phone to call a location-announcement service. In response, the service queries the GPS receiver for the person's geographical coordinates, translates the coordinates into user-friendly information that is readily understandable by the person, and announces the user-friendly information to the person via the cellular phone, all without human involvement.

### (8) United States Patent Application Publication Number US 2008/0120029 A1 to Zelek et al.

United States Patent Application Publication Number US 2008/0120029 A1 published to Zelek et al. on May 22, 2008 in U.S. class 701 and subclass 213 teaches a wearable tactile navigation system freeing a user from requiring to use the user's eyes as there is no display, all positional information is conveyed via touch. As a compass, the device nudges the user towards North. As a GPS navigator, the device orients the user towards a landmark, i.e., home, and lets the user feel how far away home is. A bluetooth interface provides network capabilities allowing the user to download map landmarks from a cell phone. The bidirectional networking capability generalizes the device to a platform capable of collecting any sensor data, as well as providing tactile messages and touch telepresence. The main application of the device is a wayfinding device for people that are blind and for people that suffer from Alzheimer's disease, but there are many other applications where it is desirable to provide geographical information in tactile form, as opposed to providing it in visual or auditory form.

It is apparent that numerous innovations for navigators have been provided in the prior art, which are adapted to be used. Furthermore, even though these innovations may be suitable for the specific individual purposes to which they address, nevertheless, they would not be suitable for the purposes of the embodiments of the present invention as heretofore described, namely, a light-weight, portable, and wireless navigator for determining when a user who is visually-impaired and/or poorly-oriented can safely cross a street, with or without a traffic light, and know his/her exact location at any given time, and given correct and detailed guidance for translocation.

### 2. SUMMARY OF THE INVENTION

Thus, an object of the embodiments of the present invention is to provide a light-weight, portable, and wireless navigator for determining when a user who is visually-impaired and/or poorly-oriented can safely cross a street, with or without a traffic light, and know his/her exact location at any given time, and given correct and detailed guidance for translocation, which avoids the disadvantages of the prior art.

Briefly stated, another object of the embodiments of the present invention is to provide a light-weight, portable, and wireless navigator for determining when a user who is visually-impaired and/or poorly-oriented can safely cross a street, with or without a traffic light, and know his/her exact location at any given time, and given correct and detailed guidance for translocation. The navigator includes a first microcomputer, a transmitter, a receiver, a second microcomputer, and an alerting device. The first microcomputer is disposed at the traffic light and determines light status of the traffic light. The transmitter is operatively connected to the first microcomputer, and generates a signal indicative of the light status of the traffic light. The receiver is hand-held/portable disposed with the user, and wirelessly receives the signal generated by the transmitter. The second microcomputer is hand-held/portable disposed with the user, is operatively connected to the receiver, and in response to the signal received by the receiver, causes the alerting device to indicate to the user the light status of the traffic light, the identification of the street, and the exact location of the user on that street so as to allow the user to identify the street and safely cross the street.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying FIGURE of the drawing.

### 3. BRIEF DESCRIPTION OF THE FIGURE OF THE DRAWING

The sole FIGURE of the drawing is a diagrammatic block diagram of the light-weight, portable, and wireless navigator of the embodiments of the present invention determining when a user who is visually-impaired and/or poorly-oriented can safely cross a street, with or without a traffic light, and know his/her exact location at any given time, and given correct and detailed guidance for translocation.

### 4. LIST OF REFERENCE NUMERALS UTILIZED IN THE FIGURE OF THE DRAWING

A. General.

10 light-weight, portable, and wireless navigator for determining when user 12 who is visually-impaired and/or poorly-oriented can safely cross street 14, with or without traffic light 16, and know his/her exact location at any given time, and given correct and detailed guidance for translocation

12 user

14 street

16 traffic light

B. Configuration of Light-Weight, Portable, and Wireless Navigator 10.

18 first microcomputer for disposing at traffic light 16

20 transmitter for disposing at traffic light 16

22 receiver for hand-held/portable disposing with user 12

24 second microcomputer for hand-held/portable disposing with user 12

26 alerting device

28 light status of traffic light 16

30 signal generated by transmitter 20 indicative of light status 28 of traffic light 16

32 cellular telephone

34 Ipod

36 loudspeaker of alerting device 26

38 headphones of alerting device 26

40 earpieces of head phones of alerting device 26

### 5. DETAILED DESCRIPTION OF THE PREFERRED EMBODIMENTS

A. General.

Referring now to the sole FIGURE of the drawing is a diagrammatic block diagram of the light-weight, portable, and wireless navigator of the embodiments of the present invention determining when a user who is visually-impaired and/or poorly-oriented can safely cross a street, with or without a traffic light, and know his/her exact location at any given time, and given correct and detailed guidance for translocation., the light-weight, portable, and wireless navigator of the embodiments of the present invention is shown generally at 10 for determining when a user 12 who is visually-impaired and/or poorly-oriented can safely cross a street 14, with or without a traffic light 16, and know his/her exact location at any given time, and given correct and detailed guidance for translocation.

B. Configuration of the Light-Weight, Portable, and Wireless Navigator 10.

The light-weight, portable, and wireless navigator 10 comprises a first microcomputer 18, a transmitter 20, a receiver 22, a second microcomputer 24, and an alerting device 26. The first microcomputer 18 is for disposing at the traffic light 16, and determines light status 28 of the traffic light 16. The transmitter 20 is for disposing at the traffic light 16, is operatively connected to the first microcomputer 18, and generates a signal 30 indicative of the light status 28 of the traffic light 16. The receiver 22 is for hand-held/portable disposing with the user 12, and wirelessly receives the signal 30 generated by the transmitter 20. The second microcomputer 24 is for hand-held/portable disposing with the user 12, is operatively connected to the receiver 22, and in response to the signal 30 received by the receiver 22, causes the alerting device 26 to indicate the light status 28 of the traffic light 16 and the identification of the street 14 to the user 12 so as to allow the user 12 to identify the street 14 and safely cross the street 14.

The light status 28 of the traffic light 16 includes, preferably, conventional green, yellow, and red.

The receiver 22 and the second microcomputer 24 can be incorporated into a cellular telephone 32 or an Ipod. 34.

The alerting device 26 includes, preferably, a loudspeaker 36 so as to be audible and allow the alerting device 26 to enunciate an appropriate message to the user 12 based upon the light status 28 of the traffic light 16, the identification of the street 14 street, and the direction that the user 12 needs to go to cross the street 14.

Sample messages can include (Baseline—the user 12 is walking facing Second Avenue):

“If you want to cross Second Avenue, it is safe because the light status 28 of the traffic light 16 at Second Avenue is green;” and

“If you want to cross First Street, turn 90 degrees to the left and please wait for the light status 28 of the traffic light 16 to be green.” This is one sample of how the user 12 will be guided, depending on which side of the street 14 the user 12 is currently on.

The alerting device 26 can also include headphones 38 having earpieces 40, respectively. If the user 12 wears glasses, than the earpieces 40 of the headphones 38 of the alerting device 26 can be incorporated into the end pieces of the temples of the glasses, respectively.

The alerting device 26 tells the user 12 where the user 12 is located within the street 14, which direction the user 12 is going, and how many more feet the user 12 needs to walk before reaching the end of the sidewalk.

The second microcomputer 24 includes a Brail and voice-sensitive communication system for input of information of destination by the user 12.

The second computer 24 further includes a complete map of streets. The alerting device 26 alerts the user 12 that the street 14 the user 12 needs to cross doesn't have a traffic light 16, and that the user 12 needs to raise his/her hand in order to alert drivers that the user 12 is crossing the street 14 or to ask for help from other pedestrians for guidance.

The alerting device 26 contains different languages so as to allow the user 12 to select a language most convenient for him/her.

The alerting device 26 tells the user 12 where the nearest subway station is, and where the nearest desired business is. For example, if the user 12 wants to go to Starbucks, the user 12 types it in and the navigator 10 directs the user 12 towards the nearest Starbucks.

C. Impressions.

It will be understood that each of the elements described above or two or more together may also find a useful application in other types of constructions differing from the types described above.

While the embodiments of the present invention have been illustrated and described as embodied in a light-weight, portable, and wireless navigator for determining when a user who is visually-impaired and/or poorly-oriented can safely cross a street, with or without a traffic light, and know his/her exact location at any given time, and given correct and detailed guidance for translocation, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A light-weight, portable, and wireless navigator for determining when a user who is visually-impaired and/or poorly-oriented can safely cross a street, with or without a traffic light, and know his/her exact location at any given time, and given correct and detailed guidance for translocation, comprising:
a) a first microcomputer;
b) a transmitter;
c) a receiver;
d) a second microcomputer; and
e) an alerting device;
wherein said first microcomputer is for disposing at the traffic light;
wherein said first microcomputer determines light status of the traffic light;
wherein said transmitter is for disposing at the traffic light;
wherein said transmitter is operatively connected to said first microcomputer;
wherein said transmitter generates a signal indicative of the light status of the traffic light;
wherein said receiver is for hand-held/portable disposing with the user;
wherein said receiver wirelessly receives said signal generated by said transmitter;
wherein said second microcomputer is for hand-held/portable disposing with the user;
wherein said second microcomputer is operatively connected to said receiver; and
wherein said second microcomputer, in response to said signal received by said receiver, causes said alerting device to indicate the light status of the traffic light and the identification of the street to the user so as to allow the user to identify the street and safely cross the street and know his/her exact location at any given time, and given correct and detailed guidance for translocation.

2. The navigator of claim 1, wherein the light status of the traffic light includes green, yellow, and red.

3. The navigator of claim 1, wherein said receiver and said second microcomputer are incorporated into a cellular telephone.

4. The navigator of claim 1, wherein said receiver and said second microcomputer are incorporated into an Ipod.

5. The navigator of claim 1, wherein said alerting device includes a loudspeaker so as to be audible and allow said alerting device to enunciate an appropriate message to the user based upon the light status of the traffic light, the identification of the street, and the direction that the user needs to go to cross the street.

6. The navigator of claim 1, wherein said alerting device includes headphones; and
wherein said headphones of said alerting device have earpieces, respectively.

7. The navigator of claim 6, wherein said earpieces of said headphones of said alerting device are incorporated into end pieces of temples of glasses, respectively.

8. The navigator of claim 1, wherein said alerting device tells the user where the user is located within the street, which direction the user is going, and how many more feet the user needs to walk before reaching the end of the sidewalk.

9. The navigator of claim 1, wherein said second microcomputer includes a Brail and voice-sensitive communication system for input of information of destination by the user.

10. The navigator of claim 1, wherein said second computer includes a complete map of streets; and
wherein said alerting device alerts the user that the street the user needs to cross doesn't have a traffic light, and that the user needs to raise his/her hand in order to alert drivers that the user is crossing the street or to ask for help from other pedestrians for guidance.

11. The navigator of claim 1, wherein said alerting device contains different languages so as to allow the user to select a language most convenient for him/her.

12. The navigator of claim 1, wherein said alerting device tells the user where the nearest subway station is, and where the nearest desired business is.
